(19) United States
(12) Patent Application Publication
(10) Pub. No.: US 2025/0125758 A1
(43) Pub. Date: Apr. 17, 2025

(54) MOTOR DRIVE CONTROL DEVICE, MOTOR UNIT, AND MOTOR DRIVE CONTROL METHOD

(71) Applicant: MINEBEA MITSUMI Inc., Kitasaku-gun, Nagano (JP)

(72) Inventors: Masato AOKI, Kitasaku-gun, Nagano (JP); Hiroyuki KAIDU, Kitasaku-gun, Nagano (JP); Takahiro SUZUKI, Kitasaku-gun, Nagano (JP)

(21) Appl. No.: 18/730,506

(22) PCT Filed: Feb. 14, 2023
(86) PCT No.: PCT/JP2023/004910

§ 371 Date: Jul. 19, 2024

(30) Foreign Application Priority Data
Feb. 21, 2022 (JP) 2022-025056

(51) Int. Cl. H02P 27/08

(52) U.S. Cl. CPC H02P 27/08

(57) ABSTRACT

The rotation speed of a motor is made to more reliably approach a target rotation speed. A motor drive control device includes: a drive circuit configured to apply an AC voltage converted by switching a DC voltage (VDD) to a coil of a motor based on a drive control signal (Sd) for controlling drive of the motor; and a control circuit configured to perform PWM control for generating a PWM signal as the drive control signal (Sd) in a manner that a rotation speed (Sr) of the motor matches a target rotation speed (Stg) and a sinusoidal current flows through the coil. The control circuit generates the PWM signal by increasing a modulation degree indicating a ratio of a command value of the AC voltage relative to the DC voltage (VDD) when the rotation speed (Sr) has not reached the target rotation speed (Stg).

### TECHNICAL FIELD

The present invention relates to a motor drive control device, a motor unit, and a motor drive control method.

### BACKGROUND ART

Conventionally, as a motor drive control method, a Pulse Width Modulation (PWM) control method for generating a PWM signal in accordance with the rotation speed of a motor and driving the motor such that a sinusoidal current flows through a coil of the motor is known (see, e.g., Patent Document 1).

### CITATION LIST

### Patent Literature

PTL 1: JP 2016-5349 A

### SUMMARY OF INVENTION

### Technical Problem

However, in the conventional PWM control method, even when the PWM signal is generated at the optimum advance angle value such that the operation amount of the motor is maximized, the rotation speed of the motor may not reach the target rotation speed depending on, for example, the magnitude of the load of the motor.

The present invention is intended to solve the problems described above, and it is an object of the present invention to make the rotation speed of the motor more reliably approach the target rotation speed.

### Solution to Problem

A motor drive control device according to an exemplary embodiment of the present invention includes a drive circuit configured to apply an AC voltage converted by switching a DC voltage to a coil of a motor based on a drive control signal for controlling drive of the motor, and a control circuit configured to perform PWM control for generating a PWM signal as the drive control signal in a manner that a rotation speed of the motor matches a target rotation speed and a sinusoidal current flows through the coil. The control circuit generates the PWM signal by increasing a modulation degree indicating a ratio of a command value of the AC voltage relative to the DC voltage when the rotation speed has not reached the target rotation speed.

### Advantageous Effects of Invention

According to one aspect of the present invention, the rotation speed of the motor can be more reliably made to approach the target rotation speed.

### BRIEF DESCRIPTION OF DRAWINGS

FIG. 1 is a diagram illustrating a configuration of a motor unit provided with a motor drive control device according to an embodiment.

FIG. 2 is a diagram showing an example of a current flowing through a coil of a motor driven by a motor drive control device according to the embodiment.

FIG. 3 is a diagram showing an example of a modulation waveform table with a modulation degree being a reference value (100%).

FIG. 4A is a diagram showing an example of a modulation waveform table with a modulation degree set to a value (105%) greater than the reference value (100%).

FIG. 4B is a diagram showing an example of a modulation waveform table with a modulation degree set to a value (110%) greater than the reference value (100%).

FIG. 4C is a diagram showing an example of a modulation waveform table with a modulation degree set to a value (115%) greater than the reference value (100%).

FIG. 4D is a diagram showing an example of a modulation waveform table with a modulation degree set to a value (120%) greater than the reference value (100%).

FIG. 5 is a diagram illustrating an example of a processing flow related to generating a PWM signal.

FIG. 6 is a diagram showing an example of a change in rotation speed of a motor 3 when the modulation degree of PWM control is changed by the motor drive control device according to the embodiment.

### DESCRIPTION OF EMBODIMENTS

### 1. Overview of Embodiments

First, an overview of typical embodiments of the invention disclosed in the present application will be described. In the following description, by way of example, reference signs in the drawings corresponding to components of the invention are indicated in parentheses.
[1] A motor drive control device (2) according to an exemplary embodiment of the present invention, includes a drive circuit (6) configured to apply an AC voltage converted by switching a DC voltage (VDD) to a coil of a motor (3) based on a drive control signal (Sd) for controlling drive of the motor, and a control circuit (5) configured to perform PWM control for generating a PWM signal as the drive control signal in a manner that a rotation speed (Sr) of the motor matches a target rotation speed (Stg) and a sinusoidal current flows through the coil. The control circuit generates the PWM signal by increasing a modulation degree indicating a ratio of a command value of the AC voltage relative to the DC voltage when the rotation speed has not reached the target rotation speed.
[2] In the motor drive control device according to above [1], the control circuit may calculate a modulation magnification (Sm) representing an operation amount for setting a deviation (Sdf) of the rotation speed relative to the target rotation speed in the PWM control, and the control circuit may increase the modulation degree stepwise from a reference value when the modulation magnification is a maximum value (e.g., 100%) and the rotation speed has not reached the target rotation speed.
[3] In the motor drive control device according to above [2], the control circuit sets the modulation degree to a value (e.g., 105% to 120%) higher than the reference value, and then, when the modulation magnification is smaller than the maximum value, may reduce the modulation degree stepwise to the reference value.
[4] In the motor drive control device according to above [2] or [3], the control circuit includes an electric angle calculation unit (12) configured to calculate an electric angle (Sφ) of the motor, and a PWM signal generation unit (13), including a modulation waveform table (170 to 171) defining a duty cycle of the PWM signal for each electric angle according to the modulation degree and configured to determine, based on the modulation waveform table, the duty cycle corresponding to the electric angle, to adjust the duty cycle according to the modulation magnification, and then to generate the PWM signal having the adjusted duty cycle. The PWM signal generation unit, when changing the modulation degree, may generate the PWM signal using the modulation waveform table (171 to 174) corresponding to the modulation degree after the change.
[5] In the motor drive control device according to above [4], the PWM signal generation unit includes a deviation calculation unit (14) configured to calculate the deviation, a modulation magnification calculation unit (15) configured to calculate the modulation magnification based on the deviation, a storage unit (17) configured to store a basic modulation waveform table being the modulation waveform table (170) at a time when the modulation degree is the reference value, and difference information (171A to 174A), relative to the basic modulation waveform table, of the modulation waveform table at a time when the modulation degree is different from the reference value, and a signal generation unit (16) configured to adjust the duty cycle of the PWM signal for each electric angle in the modulation waveform table based on the modulation magnification and to generate the PWM signal having the adjusted duty cycle. The signal generation unit, when changing the modulation degree to a value different from the reference value, may generate the modulation waveform table (171 to 174) at the time when the modulation degree is a value different from the reference value, based on, stored at the storage unit, the modulation waveform table at the time when the modulation degree is the reference value and the difference information.
[6] In the motor drive control device according to above [4], the PWM signal generation unit includes a deviation calculation unit (14) configured to calculate the deviation, a modulation magnification calculation unit (15) configured to calculate the modulation magnification based on the deviation, a storage unit (17) configured to store a plurality of modulation waveform tables (171 to 174) with different modulation degrees from each other, and a signal generation unit (16) configured to adjust the duty cycle of the PWM signal for each electric angle in the modulation waveform table based on the modulation magnification and to generate the PWM signal having the adjusted duty cycle. The signal generation unit, when changing the modulation degree, may select a modulation waveform table (171 to 174) corresponding to the changed modulation degree from among the plurality of modulation waveform tables stored at the storage unit, and generate the PWM signal.
[7] A motor unit (1) according to an exemplary embodiment of the present invention, includes the motor drive control device (2) according to any one of above [1] to [6], and the motor (3).
[8] A motor drive control method according to an exemplary embodiment of the present invention, includes a first step (S1 to S8) of performing PWM control to generate a PWM signal in a manner that a rotation speed of a motor matches a target rotation speed and a sinusoidal current flows through a coil of the motor, and a second step of applying an AC voltage converted by switching a DC voltage to the coil based on the PWM signal generated in the first step. The first step includes a step (S1 to S4, S7, S8) of generating the PWM signal by increasing stepwise a modulation degree indicating a ratio of a command value of the AC voltage relative to the DC voltage when the rotation speed has not reached the target rotation speed.

### 2. Specific Examples of Embodiments

Hereinafter, specific examples of embodiments of the present invention will be described with reference to the drawings. In the following description, the same reference signs will be used for common components in each embodiment, and repeated descriptions will be omitted.

### Embodiments

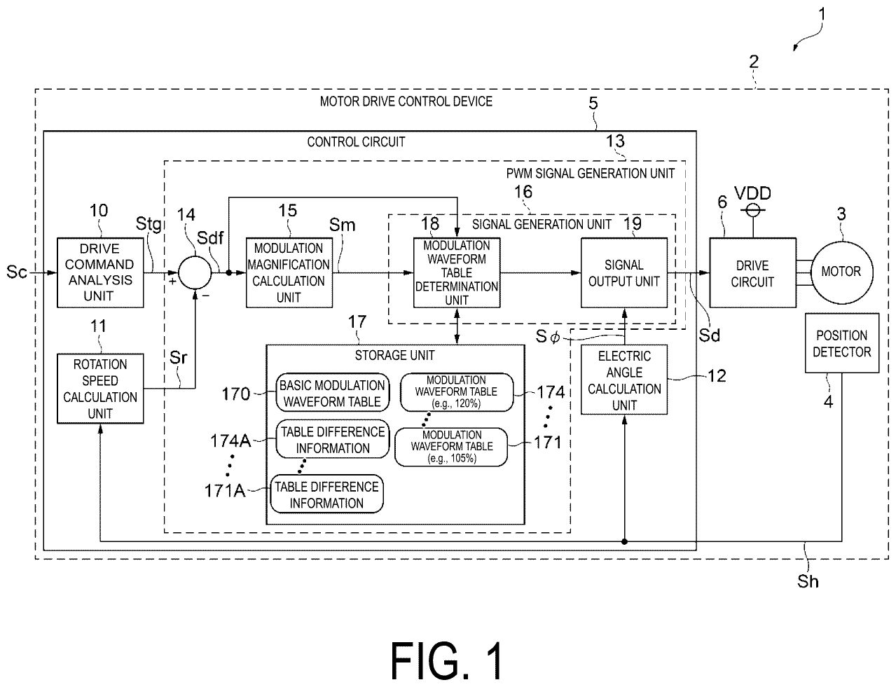

FIG. 1 is a diagram illustrating a configuration of a motor unit including a motor drive control device according to an embodiment.

A motor unit 1 illustrated in FIG. 1 includes a motor 3, a position detector 4, and a motor drive control device 2.

The motor 3 includes at least one coil. The motor 3 is, for example, a brushless DC motor including coils (windings) of three phases (U-phase, V-phase, and W-phase). The motor 3 functions as one fan motor, for example, by coupling an impeller (not illustrated) to the output shaft of the motor 3.

The position detector 4 is a device for generating a position detection signal Sh according to rotation of the rotor of the motor 3. The position detector 4 includes, for example, a Hall element. In the motor unit 1 according to the present embodiment, Hall elements are provided at respective positions corresponding to the coils of U-phase, V-phase, and W-phase of the motor 3. Each Hall element detects the magnetic pole of the rotor and outputs a Hall signal with the voltage changing according to the rotation of the rotor. The Hall signal output from the position detector 4 is, for example, a pulse signal, and is input to the motor drive control device 2 as the position detection signal Sh.

The motor drive control device 2 controls the drive of the motor 3. The motor drive control device 2 drives the motor 3, for example, by performing PWM control to generate a PWM signal such that a rotation speed Sr of the motor 3 matches a target rotation speed Stg and a sinusoidal current flows through the coils of the motor 3.

The motor drive control device 2 includes a control circuit 5 and a drive circuit 6. The motor drive control device 2 receives supply of DC voltage from an external DC power supply (not illustrated). The DC voltage is supplied to a power supply line (not illustrated) in the motor drive control device 2 via a protection circuit or the like, for example, and is input as a power supply voltage to the control circuit 5 and the drive circuit 6 via the power supply line. Hereinafter, the power supply voltage supplied to the drive circuit 6 is also referred to as “DC voltage VDD”.

The drive circuit 6 is a circuit for driving the motor 3 based on a drive control signal Sd output from the control circuit 5. The drive control signal Sd is a signal for controlling the drive of the motor 3 and is, for example, a PWM signal.

The drive circuit 6 includes, for example, an inverter circuit including a plurality of transistors as switch elements. The drive circuit 6 switches the connection destination of the coil of each phase of the motor 3 between the DC voltage VDD and a ground potential in accordance with the PWM signal as the drive control signal Sd. Specifically, the drive circuit 6 applies the AC voltage converted by switching the DC voltage VDD to the coil of each phase of the motor 3 based on the PWM signal as the drive control signal Sd.

Note that the drive circuit 6 may include a pre-drive circuit for driving the transistors constituting the inverter circuit described above based on the drive control signal Sd. A sense resistor for detecting the current of the coil of the motor may be connected to the inverter circuit.

The control circuit 5 is a circuit for comprehensively controlling the operation of the motor drive control device 2. In the present embodiment, the control circuit 5 is a program processing device having a configuration in a manner that a processor such as a CPU, various storage devices such as a RAM, a ROM, and a flash memory, and peripheral circuits such as a counter (timer), an A/D conversion circuit, a D/A conversion circuit, a clock generation circuit, and an input/output interface circuit are connected to each other via a bus or a dedicated line. For example, the control circuit 5 is a micro controller unit (MCU).

Note that the control circuit 5 and the drive circuit 6 may be packaged as one semiconductor integrated circuit (IC), or may be packaged as individual integrated circuit devices, mounted on a circuit board, and electrically connected to each other on the circuit board.

The control circuit 5 performs PWM control. That is, the control circuit 5 generates a PWM signal with a duty cycle determined such that the rotation speed Sr of the motor 3 matches the target rotation speed Stg and a sinusoidal current flows through the coils of the motor 3, thereby being output as the drive control signal Sd. For example, the control circuit 5 generates a PWM signal such that a sinusoidal current with the phases shifted by 120 degrees from each other flows through the U-phase, V-phase, and W-phase coils of the motor 3, thereby being provided to the drive circuit 6 as the drive control signal Sd.

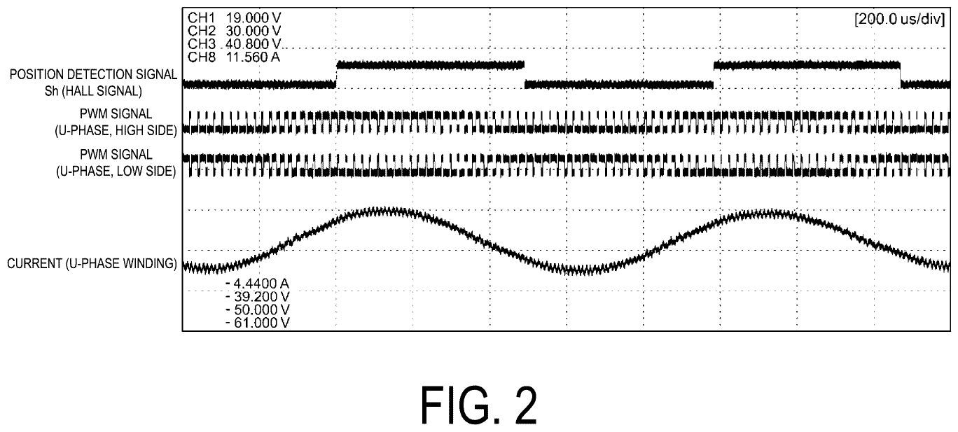

FIG. 2 is a diagram showing an example of a current flowing through the coil of the motor 3 driven by the motor drive control device 2 according to an embodiment.

FIG. 2 shows a voltage and current associated with the U-phase representatively among the U-phase, V-phase, and W-phase of the motor 3. That is, from the upper side to the lower side of FIG. 2, a waveform of the position detection signal (Hall signal) Sh, a waveform of the PWM signal for driving the switch of the high side of the U-phase inverter circuit (drive circuit 6), a waveform of the PWM signal for driving the switch of the low side of the U-phase inverter circuit (drive circuit 6), and a waveform of the current of the U-phase coil (winding), are shown.

As shown in FIG. 2, the control circuit 5 generates a pulse width modulated signal (PWM signal) such that the rotation speed Sr of the motor 3 matches the target rotation speed Stg and a sinusoidal current is generated at the coils, thereby driving each switch constituting the drive circuit 6 (inverter circuit). As a result, an AC voltage converted by switching the DC voltage VDD is applied to the coils of the respective phases of the motor 3. At this time, the average voltage of the coil is equivalent to a sinusoidal AC voltage, and a sinusoidal current flows through the coil as shown in FIG. 2.

In general, in PWM control of a motor, the ratio of the amplitude of the AC voltage to be generated to the amplitude of the carrier is called “modulation degree (modulation rate)”. In the present embodiment, the ratio of the command value of the AC voltage to the DC voltage VDD is defined as the modulation degree.

The control circuit 5 determines a pulse width (duty cycle) of the PWM signal in accordance with a deviation Sdf of the rotation speed Sr relative to the target rotation speed Stg and an electric angle Sφ such that an equivalent AC voltage (average voltage) corresponding to the set modulation degree is applied to the coils of the motor 3 in the PWM control. In addition to the function of the PWM control described above, the control circuit 5 has a function of increasing the modulation degree when the rotation speed Sr of the motor 3 has not reached the target rotation speed Stg.

Specifically, the control circuit 5 calculates a modulation magnification Sm representing an operation amount for setting the deviation Sdf to zero of the rotation speed Sr relative to the target rotation speed Stg in the PWM control. Then, when the modulation magnification Sm is the maximum value and the rotation speed Sr has not reached the target rotation speed Stg, the modulation degree is increased stepwise from a reference value. Alternatively, the control circuit 5 may also decrease the modulation degree stepwise to the reference value when the modulation magnification Sm is smaller than the maximum value. A specific configuration example of the control circuit 5 for achieving the above functions will be described in detail below.

For example, as illustrated in FIG. 1, the control circuit 5 includes a drive command analysis unit 10, a rotation speed calculation unit 11, an electric angle calculation unit 12, and a PWM signal generation unit 13.

Each of the above functional units constituting the control circuit 5 is achieved, for example, by program processing via the MCU as the control circuit 5. Specifically, the processor constituting the MCU as the control circuit 5 performs various arithmetic calculations according to the program stored in the memory to control each peripheral circuit constituting the MCU, thereby realizing the drive command analysis unit 10, the rotation speed calculation unit 11, the electric angle calculation unit 12, and the PWM signal generation unit 13.

The drive command analysis unit 10 receives, for example, a drive command signal Sc output from a host device (not illustrated) provided outside the motor drive control device 2. The drive command signal Sc is a signal indicating a target value for driving the motor 3, for example, a speed command signal indicating the target rotation speed Stg of the motor 3.

The drive command analysis unit 10 acquires the information of the specified target rotation speed Stg by analyzing the drive command signal Sc. For example, when the drive command signal Sc is a PWM signal having a duty cycle corresponding to the target rotation speed Stg, the drive command analysis unit 10 analyzes the duty cycle of the drive command signal Sc and outputs the information of the rotation speed corresponding to the duty cycle as the target rotation speed Stg.

The rotation speed calculation unit 11 is a functional unit for calculating the actual rotation speed Sr of the motor 3. For example, the rotation speed calculation unit 11 calculates and outputs the rotation speed Sr of the motor 3 based on the position detection signal Sh (e.g., a Hall signal) output from the position detector 4 by a known arithmetic calculation method.

The electric angle calculation unit 12 is a functional unit for calculating the electric angle Sφ corresponding to the position (rotation angle) of the rotor of the motor 3. For example, the electric angle calculation unit 12 calculates the electric angle Sφ of the rotor based on the position detection signal Sh (e.g., a Hall signal) output from the position detector 4 by a known arithmetic calculation method.

The PWM signal generation unit 13 is a functional unit for generating a PWM signal as the drive control signal Sd, based on the target rotation speed Stg analyzed by the drive command analysis unit 10, the rotation speed Sr calculated by the rotation speed calculation unit 11, and the electric angle Sφ calculated by the electric angle calculation unit 12.

Here, an outline of the method for generating the PWM signal by the PWM signal generation unit 13 will be described.

The PWM signal generation unit 13 includes, for example, a modulation waveform table, adjusts the duty cycle corresponding to the electric angle Sφ calculated based on the modulation waveform table in accordance with the modulation magnification Sm, and outputs a PWM signal having the adjusted duty cycle.

Here, the modulation magnification Sm is information indicating the operation amount to reduce the deviation Sdf of the rotation speed Sr to zero relative to the target rotation speed Stg, as described above. Specifically, the modulation magnification Sm can be calculated by performing Proportional-Integral-Differential (PID) control arithmetic calculation such that the deviation Sdf becomes zero. The modulation magnification Sm is, for example, a value in the range from 0% to 100%.

The modulation waveform table is data with the duty cycle of the PWM signal for each electric angle Sφ determined according to the modulation degree. In other words, the modulation waveform table is information with the duty cycle of the PWM signal required to apply the equivalent AC voltage (average voltage) corresponding to the set modulation degree to the coil being determined for each electric angle Sφ of the motor 3 (rotor).

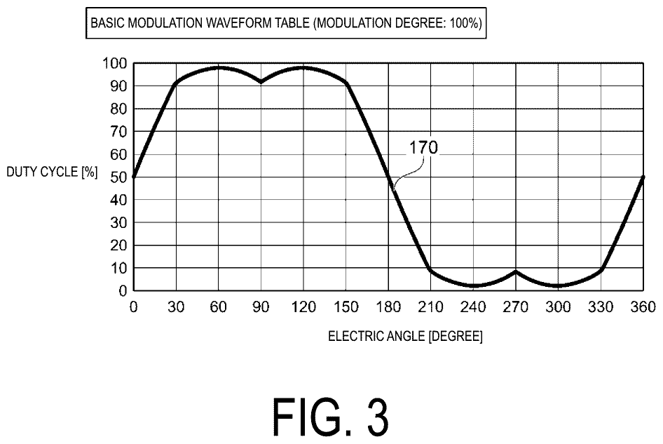

FIG. 3 is a diagram showing an example of a modulation waveform table with the modulation degree being a reference value (100%).

In FIG. 3, the horizontal axis represents the electric angle Sφ, and the vertical axis represents the duty cycle of the PWM signal. The modulation waveform with reference sign (hereinafter referred to as “modulation waveform table”) 170 represents a modulation waveform (basic modulation waveform) defining the duty cycle of the PWM signal for each electric angle Sφ of the motor 3. The modulation waveform table 170 is required to apply the equivalent AC voltage (average voltage) with a modulation degree of 100% to the coil when the modulation magnification Sm is set to 100%. The modulation waveform of the modulation waveform table 170 can be calculated, for example, by adding the intermediate voltage of the AC voltage as a common mode voltage to the AC voltage (phase voltage) to be applied to the coil of each phase of the motor 3 by the so-called intermediate voltage ½ superposition method, and calculating the modulation degree of each phase. In the following description, the modulation waveform table 170 when the modulation degree is the reference value (100%) and the modulation magnification Sm is 100% is also referred to as a “basic modulation waveform table 170”.

The PWM signal generation unit 13 stores the basic modulation waveform table 170 including the waveform information shown in FIG. 3 at an internal storage area in advance, and determines the duty cycle of the PWM signal to be generated based on the modulation magnification Sm calculated based on the deviation Sdf of the rotation speed and the electric angle Sφ calculated by the electric angle calculation unit 12, by using the basic modulation waveform table 170.

For example, when the modulation magnification Sm calculated based on the deviation Sdf of the rotation speed is 100%, the PWM signal generation unit 13 reads the duty cycle corresponding to the electric angle Sφ calculated by the electric angle calculation unit 12 from the basic modulation waveform table 170 of FIG. 3, and outputs the PWM signal with the read duty cycle.

For example, when the modulation magnification Sm calculated based on the deviation Sdf of the rotation speed is 75%, the PWM signal generation unit 13 reads the duty cycle corresponding to the electric angle Sφ from the basic modulation waveform table 170 of FIG. 3, adjusts the read duty cycle by the modulation magnification Sm (75%), and sets the adjusted duty cycle as the duty cycle of the PWM signal to be generated. For example, the PWM signal generation unit 13 sets, as the duty cycle of the PWM signal to be generated, the value obtained by multiplying the duty cycle read from the basic modulation waveform table 170 by 0.75 (75%).

In this way, the PWM signal generation unit 13 determines the duty cycle of the PWM signal based on the basic modulation waveform table 170, the electric angle Sφ, and the modulation magnification Sm.

Next, a method for changing the modulation degree in PWM control by the motor drive control device 2 will be described.

In general, to increase the rotation speed Sr of the motor in PWM control of the motor, it is necessary to increase the effective value of the equivalent AC voltage applied to the coil of the motor and to increase the effective value of the current of the coil. The maximum effective value of the equivalent AC voltage applied to the coil is determined by the modulation degree.

However, as described above, depending on the motor load, or the like, even when the PWM signal is generated at the optimum advance angle value such that the motor operation amount (modulation magnification Sm) is maximized when the modulation degree in the PWM control is set to 100%, the motor rotation speed Sr may not reach the target rotation speed Stg.

Thus, in the motor drive control device 2 according to the present embodiment, when the motor rotation speed Sr does not reach the target rotation speed Stg, the modulation degree in the PWM control is made higher than the reference value (e.g., 100%), thereby increasing the maximum value of the effective value of the equivalent AC voltage applied to the coil and increasing the rotation speed Sr of the motor 3.

Specifically, when the rotation speed Sr has not reached the target rotation speed Stg, the PWM signal generation unit 13 generates a PWM signal using a modulation waveform table with a duty cycle adjusted such that the modulation degree is higher than the reference value. The details will be described below.

In the present embodiment, an example will be described that the reference value of the modulation degree in the PWM control is “100%” and the maximum value of the modulation degree is 120%, but no limitation is intended.

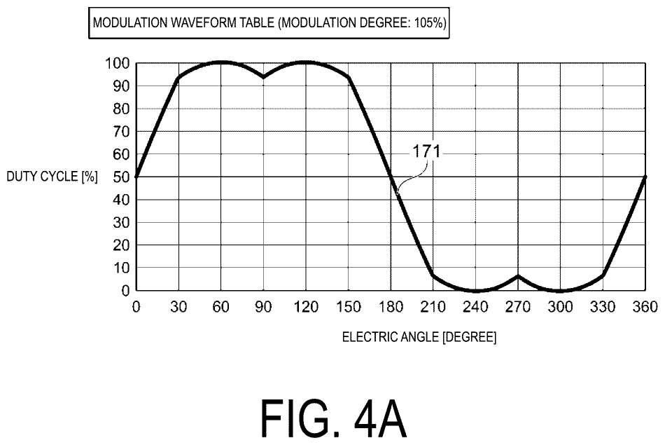

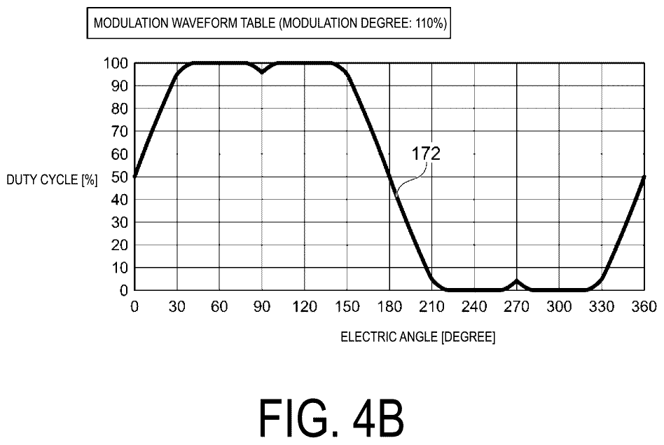

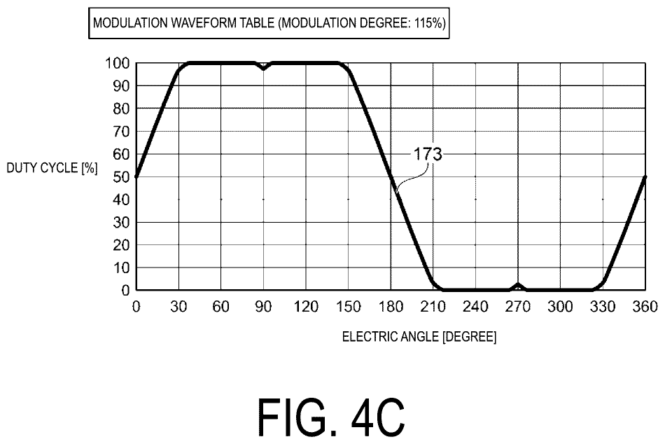

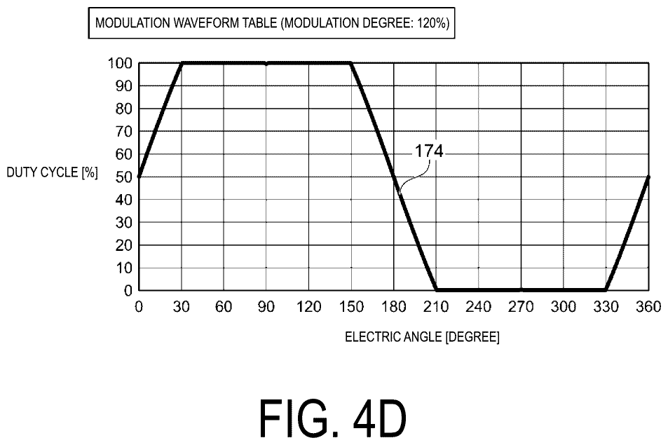

FIGS. 4A to 4D are diagrams showing an example of modulation waveform tables when the modulation degree is set to a value larger than the reference value (100%). Specifically, FIG. 4A shows an example of a modulation waveform table when the modulation degree is set to a value (105%) greater than the reference value (100%). FIG. 4B shows an example of a modulation waveform table when the modulation degree is set to a value (110%) greater than the reference value (100%). FIG. 4C shows an example of a modulation waveform table when the modulation degree is set to a value (115%) greater than the reference value (100%). FIG. 4D shows an example of a modulation waveform table when the modulation degree is set to a value (120%) greater than the reference value (100%).

In FIGS. 4A to 4D, the horizontal axis represents electric angle Sφ, and the vertical axis represents the duty cycle of the PWM signal. FIG. 4A shows a modulation waveform table 171 (modulation magnification Sm is 100%) with the duty cycle for each electric angle Sφ adjusted such that the modulation degree is 105%. FIG. 4B shows a modulation waveform table 172 (modulation magnification Sm is 100%) with the duty cycle for each electric angle Sφ adjusted such that the modulation degree is 110%. FIG. 4C shows a modulation waveform table 173 (modulation magnification Sm is 100%) with the duty cycle for each electric angle Sφ adjusted such that the modulation degree is 115%. FIG. 4D shows a modulation waveform table 174 (modulation magnification Sm is 100%) with the duty cycle for each electric angle Sφ adjusted such that the modulation degree is 120%.

When the modulation degree is changed, the PWM signal generation unit 13 generates a PWM signal using a modulation waveform table corresponding to the modulation degree after the change. For example, the PWM signal generation unit 13 increases the modulation degree from the reference value (100%) to the maximum value (e.g., 120%) for each predetermined amount α (e.g., α is 5%).

For example, when the modulation degree is the reference value (100%) and the modulation magnification Sm is the maximum value (100%) and the rotation speed Sr has not reached the target rotation speed Stg, the PWM signal generation unit 13 changes the modulation degree from the reference value to 105% and changes the modulation waveform table used from, for example, the basic modulation waveform table 170 shown in FIG. 3 to the modulation waveform table 171 shown in FIG. 4A.

Next, the PWM signal generation unit 13 reads the duty cycle corresponding to the electric angle Sφ calculated by the electric angle calculation unit 12 from the modulation waveform table 171, adjusts the read duty cycle according to the modulation magnification Sm (0% to 100%) by the method described above, and outputs the PWM signal with the adjusted duty cycle. As a result, the equivalent AC voltage with an effective value of 1.05 times (105%) is theoretically applied to the coil of the motor 3 as compared to the case with the modulation degree 100%, and the rotation speed Sr of the motor 3 can be further increased.

Since the maximum value of the voltage applied to the coil is limited to the DC voltage VDD, the amplitude of the equivalent AC voltage actually applied to the coil does not become 105% of the DC voltage VDD. That is, when the modulation degree is set to 100% or more, an AC voltage distorted relative to the sinusoidal voltage for the modulation degree of 100% is applied to the coil.

After the modulation degree is set to 105%, when the modulation magnification Sm is the maximum value (100%) and the rotation speed Sr has not reached the target rotation speed Stg, the PWM signal generation unit 13 further increases the modulation degree. That is, the PWM signal generation unit 13 changes the modulation degree from 105% to 110% and generates a PWM signal using, for example, the modulation waveform table 172 shown in FIG. 4B. The method of generating the PWM signal in this case is the same as the method in the case with the modulation degree 105%.

Thus, the PWM signal generation unit 13 increases the modulation degree stepwise when the modulation magnification Sm is the maximum value and the rotation speed Sr has not reached the target rotation speed Stg. Thus, the rotation speed Sr of the motor 3 can be increased stepwise such that the rotation speed Sr of the motor 3 reaches the target rotation speed Stg.

On the other hand, when a PWM signal is generated with a modulation degree exceeding 100%, the motor 3 tends to oscillate easily. Thus, the PWM signal generation unit 13 may reduce the modulation degree stepwise to the reference value when the modulation magnification Sm is smaller than the maximum value (100%).

For example, the PWM signal generation unit 13 may set a threshold Sth of the modulation magnification Sm for switching the modulation degree, and may reduce the modulation degree stepwise to the reference value of 100% when the modulation magnification Sm becomes no more than the threshold Sth. For example, the PWM signal generation unit 13 reduces the modulation degree to the reference value (100%) for each predetermined amount β (e.g., 5%).

The threshold Sth of the modulation magnification Sm can be set to any value, but in the present embodiment, as an example, the threshold Sth is set to 95%.

Specifically, in a state that the PWM signal is generated with the modulation degree set to 120%, for example, when the modulation magnification Sm decreases to 90% due to the fact that the rotation speed Sr of the motor 3 approaches the target rotation speed Stg, the PWM signal generation unit 13 detects that the modulation magnification Sm (equal to 90%) is no more than the threshold Sth (equal to 95%), and changes the modulation degree from 120% to 115%. That is, the PWM signal generation unit 13 changes the modulation waveform table 174 with the modulation degree set to 120% to the modulation waveform table 173 with the modulation degree set to 115%, and generates the PWM signal.

When, for example, the modulation magnification Sm is reduced to 93% after the modulation degree is reduced to 115%, the PWM signal generation unit 13 detects that the modulation magnification Sm (equal to 93%) is no more than the threshold Sth (equal to 95%), and reduces the modulation degree from 115% to 110%. That is, the PWM signal generation unit 13 changes from the modulation waveform table 173 with a modulation degree of 115% to the modulation waveform table 172 with a modulation degree of 110%, and generates a PWM signal.

In this manner, the PWM signal generation unit 13 decreases the modulation degree stepwise when the modulation magnification Sm falls below the maximum value. This makes it possible to suppress the vibration of the motor 3 after the rotation speed Sr of the motor 3 reaches the target rotation speed Stg.

Next, a specific configuration example of the PWM signal generation unit 13 for achieving the above-described PWM signal generation function and modulation degree adjustment function will be described.

As illustrated in FIG. 1, the PWM signal generation unit 13 includes, for example, a deviation calculation unit 14, a modulation magnification calculation unit 15, a signal generation unit 16, and a storage unit 17.

The deviation calculation unit 14 is a functional unit calculating the deviation (speed deviation) Sdf of the rotation speed Sr of the motor 3 relative to the target rotation speed Stg. The deviation calculation unit 14 calculates deviation Sdf (equal to Stg−Sr) by, for example, subtracting the rotation speed Sr calculated by the rotation speed calculation unit 11 from the target rotation speed Stg output from the drive command analysis unit 10.

The modulation magnification calculation unit 15 is a functional unit for calculating the modulation magnification Sm. For example, as described above, the modulation magnification calculation unit 15 calculates the modulation magnification Sm by performing PID control arithmetic calculation so that the deviation Sdf calculated by the deviation calculation unit 14 becomes zero.

The storage unit 17 is a functional unit for storing various data, calculation results, or the like, necessary for achieving the function of generating a PWM signal and the function of adjusting the modulation degree. For example, the basic modulation waveform table 170 with the modulation degree a reference value (100%) is previously stored at the storage unit 17.

In addition, data concerning the modulation waveform table when the modulation degree is a value different from the reference value, is also stored in the storage unit 17. The data concerning the modulation waveform table when the modulation degree is a value different from the reference value is, for example, information (hereinafter also referred to as “table difference information”) of the difference between the basic modulation waveform table 170 and either of the modulation waveform tables 171 to 174 when the modulation degree is a value different from the reference value (105% to 120%). That is, the table difference information is the difference between the duty cycle for each electric angle Sφ in the basic modulation waveform table 170 when the modulation degree is a reference value (100%) and the duty cycle for each electric angle Sφ in either of the modulation waveform tables 171 to 174 when the modulation degree is a value different from the reference value (105% to 120%).

In the present embodiment, for example, as described above, it is assumed that respective table difference information 171A to 174A corresponding to four modulation degrees with the modulation degree greater than the reference value (100%) is stored in the storage unit 17.

For example, the table difference information 171A is data including the difference for each electric angle Sφ of the duty cycle between the basic modulation waveform table 170 and the modulation waveform table 171 with the modulation degree 105%. For example, the table difference information 172A is data including the difference for each electric angle Sφ of the duty cycle between the basic modulation waveform table 170 and the modulation waveform table 172 with the modulation degree 110%. The table difference information 173A is data including the difference for each electric angle Sφ of the duty cycle between the basic modulation waveform table 170 and the modulation waveform table 173 with the modulation degree 115%. The table difference information 174A is data including the difference for each electric angle Sφ of the duty cycle between the basic modulation waveform table 170 and the modulation waveform table 174 with the modulation degree 120%.

The storage unit 17 also stores the threshold Sth of the modulation magnification Sm, or the like described above.

The signal generation unit 16 is a functional unit generating a PWM signal based on the modulation magnification Sm calculated by the modulation magnification calculation unit 15 and the information stored in the storage unit 17. The signal generation unit 16 includes, for example, a modulation waveform table determination unit 18 and a signal output unit 19.

The modulation waveform table determination unit 18 determines the modulation waveform table used to generate the PWM signal in accordance with the driving state of the motor 3. The modulation waveform table determination unit 18 selects the basic modulation waveform table 170 set as an initial condition when the motor 3 is started, for example.

When the modulation magnification Sm is the maximum value (100%) and the rotation speed Sr has not reached the target rotation speed Stg (deviation Sdf>0), the modulation waveform table determination unit 18 changes the modulation waveform table such that the modulation degree is increased stepwise from the reference value (100%). On the other hand, the modulation waveform table determination unit 18 changes the modulation waveform table such that the modulation degree is decreased stepwise to the reference value (100%) when the modulation magnification Sm calculated by the modulation magnification calculation unit 15 becomes no more than the threshold Sth (e.g., 95%).

When changing the modulation degree to a value different from the reference value, the modulation waveform table determination unit 18 generates corresponding one of modulation waveform tables 171 to 174 corresponding to the changed modulation degree based on the basic modulation waveform table 170 and the corresponding one of the table difference information 171A to 174A stored in the storage unit 17.

Specifically, the difference of the duty cycle for each electric angle Sφ in the table difference information corresponding to the changed modulation degree among the table difference information 171A to 174A is added to the duty cycle for each electric angle Sφ in the basic modulation waveform table 170 to generate a modulation waveform table corresponding to the changed modulation degree.

For example, when the modulation degree is changed from 100% to 105%, the modulation waveform table determination unit 18 generates the modulation waveform table 171 with a modulation degree of 105% by adding the difference of the duty cycle for each electric angle Sφ stored in the table difference information 171A with a modulation degree of 105% to the duty cycle for each electric angle Sφ in the basic modulation waveform table 170, and then stored at the storage unit 17.

The signal output unit 19 generates a PWM signal based on the modulation waveform table determined by the modulation waveform table determination unit 18, the electric angle Sφ, and the modulation magnification Sm. Specifically, the signal output unit 19 refers to the modulation waveform table determined by the modulation waveform table determination unit 18 and stored at the storage unit 17, adjusts the duty cycle corresponding to the electric angle Sφ in the modulation waveform table based on the modulation magnification Sm, and generates a PWM signal having the adjusted duty cycle.

For example, when the modulation degree is 100%, the modulation magnification Sm is 75%, and the electric angle Sφ is 60 degrees, the signal output unit 19 reads the duty cycle of the PWM signal corresponding to the electric angle Sφ equaling to 60 degrees from the basic modulation waveform table 170, determines the value obtained by multiplying the read duty cycle by the modulation magnification Sm (equal to 0.75) as the duty cycle of the PWM signal to be generated, and outputs the PWM signal with the determined duty cycle as the drive control signal Sd.

When the modulation degree is changed to any of 105% to 120%, the signal generation unit 16 generates a PWM signal by the same method. For example, when the modulation degree is 110%, the modulation magnification Sm is 98%, and the electric angle Sφ is 90 degrees, the duty cycle of the PWM signal corresponding to the electric angle Sφ equaling to 90 degrees is read from the modulation waveform table 172 of the modulation degree 110%, the value obtained by multiplying the read duty cycle by the modulation magnification Sm (equal to 0.98) is determined as the duty cycle of the PWM signal to be generated, and the PWM signal with the determined duty cycle is output as the drive control signal Sd.

In the above description, a case that the duty cycle of the PWM signal to be generated is determined by multiplying the duty cycle of each electric angle Sφ read from corresponding one of the modulation waveform tables 170 to 174 by the modulation magnification Sm is exemplified, but the method for determining the duty cycle based on the modulation magnification Sm is not limited to this case.

For example, the signal generation unit 16 may correct corresponding one of the modulation waveform tables 170 to 174 based on the modulation magnification Sm, and determine the duty cycle of the PWM signal to be generated according to the corrected modulation waveform table.

Specifically, first, the modulation waveform table determination unit 18 multiplies the duty cycle of each electric angle Sφ stored in corresponding one of the modulation waveform tables 170 to 174 by the modulation magnification Sm to generate a corresponding one of new modulation waveform tables 170X to 174X with the duty cycle corrected. For example, when the modulation degree is 120% and the modulation magnification Sm is 96%, the modulation waveform table determination unit 18 generates the modulation waveform table 174 with the modulation degree of 120% by the above-described method based on the basic modulation waveform table 170 and the table difference information 174A with the modulation degree of 120%. The modulation waveform table determination unit 18 multiplies the duty cycle for each electric angle Sφ stored in the modulation waveform table 174 by the modulation magnification Sm (0.96) to generate the new modulation waveform table 174X. Next, the signal output unit 19 reads the duty cycle corresponding to the electric angle Sφ from the corresponding one of the modulation waveform tables 170X to 174X determined by the modulation waveform table determination unit 18, and generates a PWM signal with the read duty cycle.

Thus, as in the case that the duty cycle read from the modulation waveform table is adjusted by the modulation degree, it is possible to generate a PWM signal with an appropriate duty cycle corresponding to the modulation degree and the modulation magnification Sm.

Next, a processing flow related to the generation of the PWM signal by the control circuit 5 will be described.

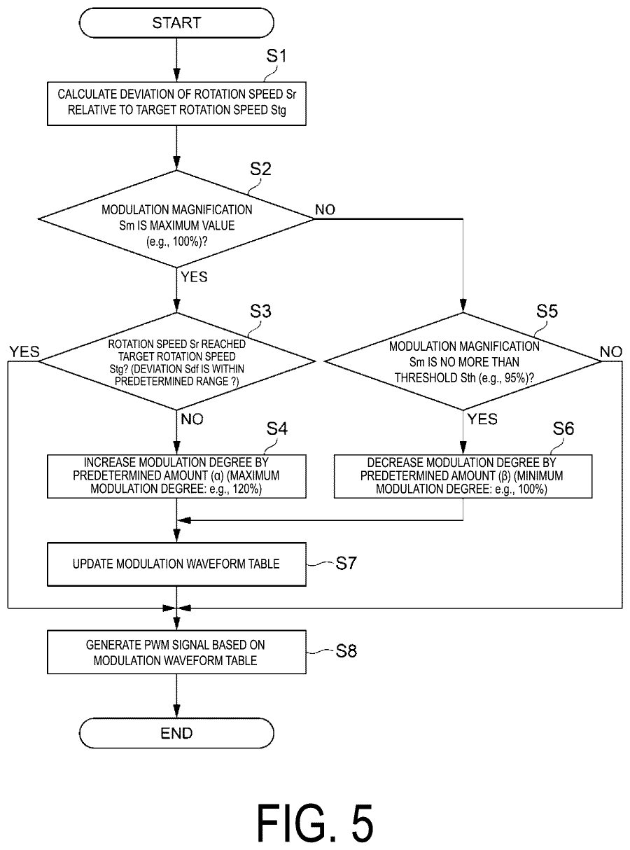

FIG. 5 is a diagram illustrating an example of a processing flow related to the generation of the PWM signal.

In this case, it is assumed that the threshold Sth of the modulation magnification Sm is set to 95%. It is also assumed that the modulation degree is set to the reference value (100%) as the initial state of the control circuit 5.

First, the deviation calculation unit 14 of the control circuit 5 calculates the deviation Sdf (equal to Stg−Sr) of the rotation speed Sr calculated by the rotation speed calculation unit 11 relative to the target rotation speed Stg analyzed by the drive command analysis unit 10 (step S1).

Next, the PWM signal generation unit 13 of the control circuit 5 determines whether the modulation magnification Sm is the maximum value (step S2). For example, first, the modulation magnification calculation unit 15 calculates the modulation magnification Sm by the above-described method based on the deviation Sdf calculated in step S1. Next, the modulation waveform table determination unit 18 determines whether the modulation magnification Sm calculated by the modulation magnification calculation unit 15 is a predetermined maximum value (e.g., 100%).

When the modulation magnification Sm is the maximum value (step S2: YES), the modulation waveform table determination unit 18 determines whether the rotation speed Sr of the motor 3 has reached the target rotation speed Stg (step S3). For example, the modulation waveform table determination unit 18 determines whether the deviation Sdf is within a predetermined range (|Sdf|<r). Note that r is any value of no less than zero.

When the deviation Sdf is within the predetermined range, i.e., the rotation speed Sr of the motor 3 has reached the target rotation speed Stg, the modulation waveform table determination unit 18 does not change the modulation waveform table, and the signal output unit 19 generates a PWM signal using the modulation waveform table (in the initial state, basic modulation waveform table 170) of the modulation degree set at that time by the method described above (step S8).

On the other hand, when the deviation Sdf is not within a predetermined range, i.e., the rotation speed Sr of motor 3 has not reached the target rotation speed Stg, the modulation waveform table determination unit 18 increases the modulation degree by a predetermined amount α (e.g., 5%) (step S4). For example, when the modulation degree is the reference value (100%), the modulation magnification Sm is 100%, and the rotation speed Sr has not reached the target rotation speed Stg, the modulation waveform table determination unit 18 changes the modulation degree from 100% to 105%.

Next, the modulation waveform table determination unit 18 updates the modulation waveform table based on the modulation degree determined in step S4 (step S7). For example, when the modulation degree is increased from 100% to 105% in step S4, the modulation waveform table determination unit 18 generates the modulation waveform table 171 with a modulation degree of 105% based on the basic modulation waveform table 170 and the table difference information 171A by the method described above. Then, the signal output unit 19 generates a PWM signal using the modulation waveform table generated in step S7 by the method described above (step S8).

In step S2, when the modulation magnification Sm is not the maximum value (step S2: NO), the modulation waveform table determination unit 18 determines whether the modulation magnification Sm is no more than the threshold Sth (95%) (step S5). When the modulation magnification Sm is not less than or equal to the threshold Sth (step S5: NO), i.e., the modulation magnification Sm is greater than 95% and less than 100%, the modulation waveform table determination unit 18 does not change the modulation waveform table. In this case, the signal output unit 19 continues to generate a PWM signal using the set modulation waveform table (in the initial state, basic modulation waveform table 170) by the method described above (step S8).

On the other hand, when the modulation magnification Sm is no more than the threshold Sth (step S5: YES), that is, the modulation magnification Sm is 95%, the modulation waveform table determination unit 18 reduces the modulation degree by the predetermined amount β (e.g., 5%) (step S6). For example, when the modulation magnification Sm drops below the threshold Sth (95%) after the modulation degree is increased to a maximum value (120%), the modulation waveform table determination unit 18 changes the modulation degree from 120% to 115%.

Next, the modulation waveform table determination unit 18 updates the modulation waveform table based on the modulation degree determined in step S6 (step S7). For example, when the modulation degree is changed from 120% to 115% in step S6 as described above, the modulation waveform table determination unit 18 generates the modulation waveform table 173 with a modulation degree of 115% based on the basic modulation waveform table 170 and the table difference information 173A by the method described above. Thereafter, the signal output unit 19 generates a PWM signal by the method described above using the modulation waveform table generated in step S7 (step S8).

The control circuit 5 repeatedly executes the above-described processing to update the modulation waveform table and generates a PWM signal.

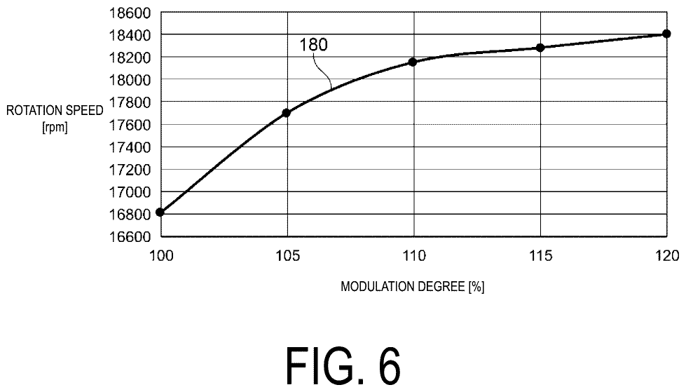

FIG. 6 is a diagram showing an example of a change in the rotation speed Sr of the motor 3 when the modulation degree of the PWM control is changed at the motor drive control device 2 according to the embodiment.

In FIG. 6, the horizontal axis represents the modulation degree [%], the vertical axis represents the rotation speed Sr [rpm] of the motor 3, and a reference sign 180 represents the characteristic of the maximum value of the rotation speed Sr relative to the modulation degree.

As shown in FIG. 6, in the motor drive control device 2 according to the present embodiment, the rotation speed Sr can be increased by increasing the modulation degree in the PWM control by the above-described method.

In the motor drive control device 2 according to the present embodiment, when the rotation speed Sr of the motor 3 has not reached the target rotation speed Stg, the control circuit 5 increases the modulation degree in the PWM control to generate the drive control signal Sd as a PWM signal to control the drive of the motor 3.

This enables the rotation speed Sr of the motor to approach the target rotation speed Stg more reliably by increasing the modulation degree in the PWM control, even when the rotation speed Sr of the motor 3 does not reach the target rotation speed Stg due to the load of the motor 3 or the like.

In addition, the control circuit 5, as described above, raises the modulation degree stepwise in the PWM control from the reference value (e.g., 100%) when the modulation magnification Sm representing the operation amount for setting to zero the deviation Sdf of the rotation speed Sr relative to the target rotation speed Stg in the PWM control, is the maximum value (e.g., 100%) and the rotation speed Sr has not reached the target rotation speed Stg.

This enables accurate detection of the state that the rotation speed Sr of the motor 3 has not reached the target rotation speed Stg, and then to raise the rotation speed Sr of the motor 3 more quickly to approach the target rotation speed Stg.

After setting the modulation degree to a value higher than the reference value (e.g., 105% to 120%), the control circuit 5 may reduce the modulation degree stepwise to the reference value (100%) when the modulation magnification Sm is smaller than the maximum value (100%). Specifically, as described above, after setting the modulation degree to a value higher than the reference value (e.g., 105% to 120%), the control circuit 5 reduces the modulation degree stepwise to the reference value (100%) when the modulation magnification Sm is no more than the threshold Sth (e.g., 95%).

This enables suppression of the vibration of the motor 3 after the rotation speed Sr of the motor 3 reaches the target rotation speed Stg. That is, it is possible to suppress the decrease in the stability of the operation of the motor 3 while improving the responsiveness of the rotation speed Sr of the motor 3.

In the motor drive control device 2 according to the present embodiment, the PWM signal generation unit 13 of the control circuit 5 includes a basic modulation waveform table 170 defining the duty cycle of the PWM signal for each electric angle Sφ according to the modulation degree, adjusts the duty cycle corresponding to the electric angle Sφ determined based on the basic modulation waveform table 170 according to the modulation magnification Sm, and generates a PWM signal having the adjusted duty cycle.

In this way, since the duty cycle of the PWM signal to be generated is determined using the modulation waveform table, complex operations such as vector arithmetic calculations are not required, and the arithmetic calculation load of the processor constituting the control circuit 5 can be suppressed.

When the modulation degree is changed, the PWM signal generation unit 13 generates the PWM signal using the modulation waveform table corresponding to the modulation degree after the change. This enables easy determination of the duty cycle of the PWM signal without performing complicated arithmetic calculations, by generating the modulation waveform table for each modulation degree or preparing the modulation waveform table for each modulation degree, as described above, even when the modulation degree is changed.

Further, in the motor drive control device 2, the storage unit 17 of the control circuit 5 stores the basic modulation waveform table 170 when the modulation degree is the reference value (100%) and each of the table difference information 171A to 174A containing the difference information of the duty cycle for each electric angle Sφ of the modulation waveform table corresponding to the changed modulation degree relative to the basic modulation waveform table 170. Then the signal generation unit 16 generates the corresponding one of the modulation waveform tables 171 to 174 corresponding to the changed modulation degree based on the basic modulation waveform table 170 and the corresponding one of the table difference information 171A to 174A.

Consequently, the amount of data previously stored in the storage unit 17 can be reduced compared with the case that the modulation waveform tables 171 to 174 themselves corresponding to the respective modulation degrees other than the reference value are stored in the storage unit 17. This enables suppression of the storage capacity of the nonvolatile storage device for achieving the storage unit 17, and suppression of the cost of the control circuit 5.

In the above example, a case that the modulation waveform tables 171 to 174 are generated based on the basic modulation waveform table 170 and the respective table difference information 171A to 174A has been described. However, not limited to this case, when the storage capacity of the nonvolatile storage device for achieving the storage unit 17 is sufficient, a plurality of modulation waveform tables 171 to 174 each having different modulation degree may be previously stored in the storage unit 17 instead of the table difference information 171A to 174A.

In this case, the modulation waveform table determination unit 18, when changing the modulation degree, selects one modulation waveform table corresponding to the changed modulation degree among the plurality of modulation waveform tables 171 to 174 stored in the storage unit 17. The signal output unit 19 generates a PWM signal using the selected modulation waveform table.

This eliminates the need for an arithmetic calculation to generate corresponding one the modulation waveform tables 171 to 174 after the modulation degree is changed, thereby further reducing the arithmetic calculation load of the processor constituting the control circuit 5.

### Expansion of Embodiments

Although the invention made by the present inventors has been specifically described based on the embodiments described above, the present invention is not limited thereto, and it is needless to say that various modifications can be made to the extent not deviating from the gist thereof.

For example, in the above embodiments, the case that both the predetermined amount a and the predetermined amount β being unit changes in the modulation degree, are 5% is exemplified, but is not limited to this case. The predetermined amounts a and B may be values other than 5%, or may be different from each other.

In the above embodiments, the motor 3 is not limited to the brushless DC motor. The motor 3 is not limited to the three phases, and may be, for example, a single-phase brushless DC motor.

In the above embodiments, a case that a Hall element is used as the position detector 4 is exemplified, but is not limited to this case. For example, a Hall IC, an encoder, a resolver or the like may be provided as the position detector 4, and their detection signals may be input to the motor drive control device 2 as the position detection signal Sh. The motor drive control device 2 may calculate the rotation speed Sr and the electric angle Sφ of the motor 3 by a known position detectorless arithmetic calculation without providing the position detector 4.

In addition, although the case that each functional unit of the control circuit 5 is achieved by program processing of the MCU is illustrated, a part or all of each functional unit of the control circuit 5 may be achieved by a dedicated circuit (hardware).

In addition, the flowchart described above is an example and is not limited to this example, for example, other processing may be inserted between each step or processing may be parallelized.

### REFERENCE SIGNS LIST

1 Motor unit; 2 Motor drive control device; 3 Motor; 4 position detector; 5 Control circuit; 6 Drive circuit; 10 Drive command analysis unit; 11 Rotation speed calculation unit; 12 Electric angle calculation unit; 13 PWM signal generation unit; 14 Deviation calculation unit; 15 Modulation magnification calculation unit; 16 Signal generation unit; 17 Storage unit; 18 Modulation waveform table determination unit; 19 Signal output unit; Sc Drive command signal (Speed command signal); Stg Target rotation speed; Sr Rotation speed; Sdf (Speed) deviation; Sm Modulation magnification; Sth Threshold of modulation magnification; Sd Drive control signal (PWM signal); Sφ Electric angle; 170 Basic modulation waveform table; 171 to 174 Modulation waveform table; 171A to 174A Table difference information

1. A motor drive control device, comprising:
a drive circuit configured to apply an AC voltage converted by switching a DC voltage to a coil of a motor based on a drive control signal for controlling drive of the motor; and
a control circuit configured to perform PWM control for generating a PWM signal as the drive control signal in a manner that a rotation speed of the motor matches a target rotation speed and a sinusoidal current flows through the coil, wherein
the control circuit generates the PWM signal by increasing a modulation degree indicating a ratio of a command value of the AC voltage relative to the DC voltage when the rotation speed has not reached the target rotation speed.

2. The motor drive control device according to claim 1, wherein
the control circuit calculates a modulation magnification representing an operation amount for setting a deviation of the rotation speed to zero relative to the target rotation speed in the PWM control, and
the control circuit increases the modulation degree stepwise from a reference value when the modulation magnification is a maximum value and the rotation speed has not reached the target rotation speed.

3. The motor drive control device according to claim 2, wherein
the control circuit sets the modulation degree to a value higher than the reference value, and then, when the modulation magnification is smaller than the maximum value, reduces the modulation degree stepwise to the reference value.

4. The motor drive control device according to claim 2, wherein
the control circuit includes:
an electric angle calculation unit configured to calculate an electric angle of the motor; and
a PWM signal generation unit including a modulation waveform table defining a duty cycle of the PWM signal for each electric angle according to the modulation degree and configured to determine, based on the modulation waveform table, the duty cycle corresponding to the electric angle, to adjust the duty cycle according to the modulation magnification, and then to generate the PWM signal having the adjusted duty cycle, and
the PWM signal generation unit, when changing the modulation degree, generates the PWM signal using the modulation waveform table corresponding to the modulation degree after the change.

5. The motor drive control device according to claim 4, wherein
the PWM signal generation unit includes:
a deviation calculation unit configured to calculate the deviation;
a modulation magnification calculation unit configured to calculate the modulation magnification based on the deviation;
a storage unit configured to store a basic modulation waveform table being the modulation waveform table at a time when the modulation degree is the reference value, and difference information, relative to the basic modulation waveform table, of the modulation waveform table at a time when the modulation degree is different from the reference value; and
a signal generation unit configured to adjust the duty cycle of the PWM signal for each electric angle in the modulation waveform table based on the modulation magnification and to generate the PWM signal having the adjusted duty cycle, and
the signal generation unit, when changing the modulation degree to a value different from the reference value, generates the modulation waveform table at the time when the modulation degree is a value different from the reference value, based on, stored at the storage unit, the modulation waveform table at the time when the modulation degree is the reference value and the difference information.

6. The motor drive control device according to claim 4, wherein
the PWM signal generation unit includes:
a deviation calculation unit configured to calculate the deviation;
a modulation magnification calculation unit configured to calculate the modulation magnification based on the deviation;
a storage unit configured to store a plurality of the modulation waveform tables with the modulation degrees different from each other; and
a signal generation unit configured to adjust the duty cycle of the PWM signal for each electric angle in the modulation waveform table based on the modulation magnification and to generate the PWM signal having the adjusted duty cycle, and
the signal generation unit, when changing the modulation degree, selects a modulation waveform table corresponding to the changed modulation degree from among the plurality of modulation waveform tables stored at the storage unit, and generates the PWM signal.

7. A motor unit, comprising:
the motor drive control device according to any one of claims 1; and
the motor.

8. A motor drive control method, comprising:
a first step of performing PWM control for generating a PWM signal in a manner that a rotation speed of a motor matches a target rotation speed and a sinusoidal current flows through a coil of the motor; and
a second step of applying an AC voltage converted by switching a DC voltage to the coil based on the PWM signal generated in the first step, wherein
the first step includes a step of generating the PWM signal by increasing stepwise a modulation degree indicating a ratio of a command value of the AC voltage relative to the DC voltage when the rotation speed has not reached the target rotation speed.
